(19) United States
(12) Patent Application Publication
(10) Pub. No.: US 2001/0037370 A1
(43) Pub. Date: Nov. 1, 2001

(54) Method and device for home page moving service

(76) Inventor: Seong-ho Shim, Seoul (KR)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/750,294

(22) Filed: Dec. 29, 2000

(30) Foreign Application Priority Data
Apr. 29, 2000 (KR) 00-23103

(51) Int. Cl. G06F 15/16

(52) U.S. Cl. 709/213

(57) ABSTRACT

A home page moving method and device therefor are provided. The home page moving method includes the steps of (a) receiving main home page data from a source server in which the home page data to be moved is stored, (b) extracting data requiring modification from the received data, (c) converting the extracted data into a format suited for the destination server by referring to a mapping table for storing mapping relationships, which are based on the environments of the source server and the destination server, and (d) transferring and transplanting home page data, including the converted data, to the destination server. The home page moving method can quickly move the home page from one server to another server without manual modification.

### BACKGROUND OF THE INVENTION

1. Field of the Invention

The present invention relates to a home page moving method and a device for performing the method, and more particularly, to a home page moving method by which a home page stored within one server is moved to another server, and a device therefor. The present application is based on Korean Patent Application No. 23103/2000, which is incorporated herein by reference.

2. Description of the Related Art

As the number of Internet users increases, the number of home pages increases. In association with home pages, there are some occasions in which a home page stored within one server needs to be moved to another server. In the related art, a user has to manually modify the contents of the home page so that it is suitable for a new home page server to which the modified home page will be moved. In other words, in order to move a home page from one server to another server, the user must manually modify the corresponding home page so that the home page is well suited for the environment of the server to which it will be moved.

However, this manual modification by the user is difficult for most beginners. Furthermore, much time is required for a job that requires manual modification and consists of many steps.

### SUMMARY OF THE INVENTION

To solve the above problems, it is an objective of the present invention to provide a home page moving method by which a home page from one server can be automatically moved to another server.

It is another objective to provide a computer-readable recording medium for storing a computer program for performing the home page moving method.

Accordingly, to achieve the above objectives, the present invention provides a home page moving method which includes the steps of: (a) receiving main home page data from a source server in which home page data to be moved is stored; (b) extracting data requiring modification from the received data; (c) converting the extracted data into a format suited for the destination server by referring to a mapping table for storing mapping relationships, which are based on the environments of the source server and the destination server; and (d) transferring and transplanting home page data, including the converted data, to the destination server.

Prior to the step (d), the home page moving method includes the steps of: (pd-1) determining whether a next page exists in a hierarchical manner; (pd-2) if it is determined that the next page exists in the step (pd-1), sending a request for the corresponding page to the source server; (pd-3) receiving the requested page from the source server; (pd-4) if it is determined that the next page does not exist in the step (pd-1), proceeding with the step (d); and (pd-5) returning to the step (b). In the step (pd-1), if a uniform resource locator (URL) is detected, it is determined in a hierarchical manner that the next page exists.

The present invention also provides a computer-readable recording medium having a computer program comprising program codes for performing a home page moving method including the steps of: (a) receiving main home page data from a source server in which home page data to be moved is stored; (b) extracting data requiring modification from the received data; (c) converting the extracted data into a format suited for the destination server by referring to a mapping table for storing mapping relationships, which are based on the environments of the source server and the destination server; and (d) transferring and transplanting home page data including the converted data to the destination server.

The present invention also provides a home page moving device including: a mapping table for mapping home page data stored in a source server into home page data to be stored in a destination server based on the environments of a common gateway interface (CGI), a database, a bulletin board of the source server for storing the home page data to be moved, and a bulletin board of the destination server; and a data converter for converting the home page data stored in the source server into a format suited for the destination server by referring to the mapping table.

### BRIEF DESCRIPTION OF THE DRAWINGS

The above objectives and advantages of the present invention will become more apparent by describing in detail a preferred embodiment thereof with reference to the attached drawings in which:

FIG. 1 is a flowchart showing the main steps of a home page moving method according to an embodiment of the present invention; and

FIG. 2 is a block diagram showing the structure of a home page moving device according to an embodiment of the invention.

### DETAILED DESCRIPTION OF THE INVENTION

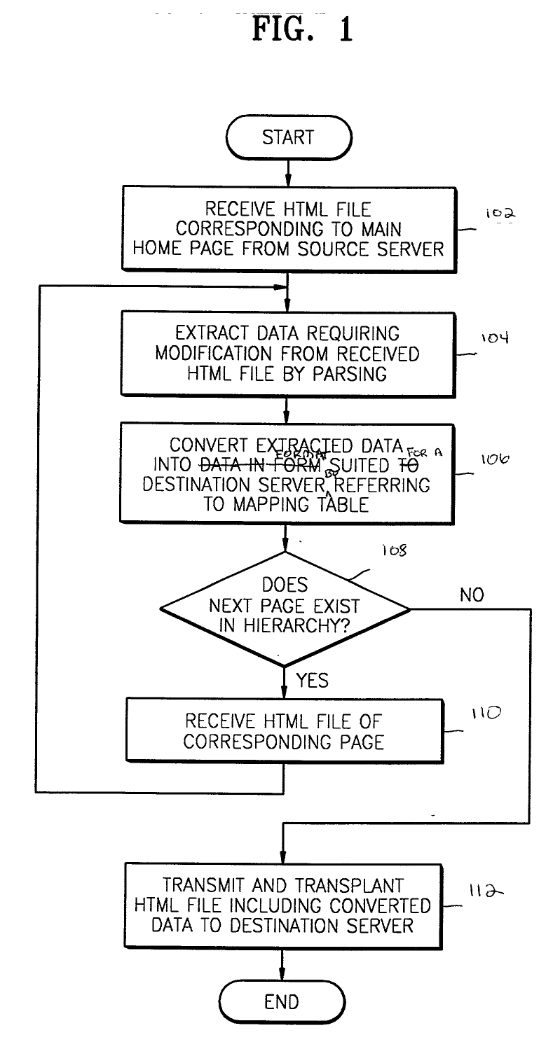

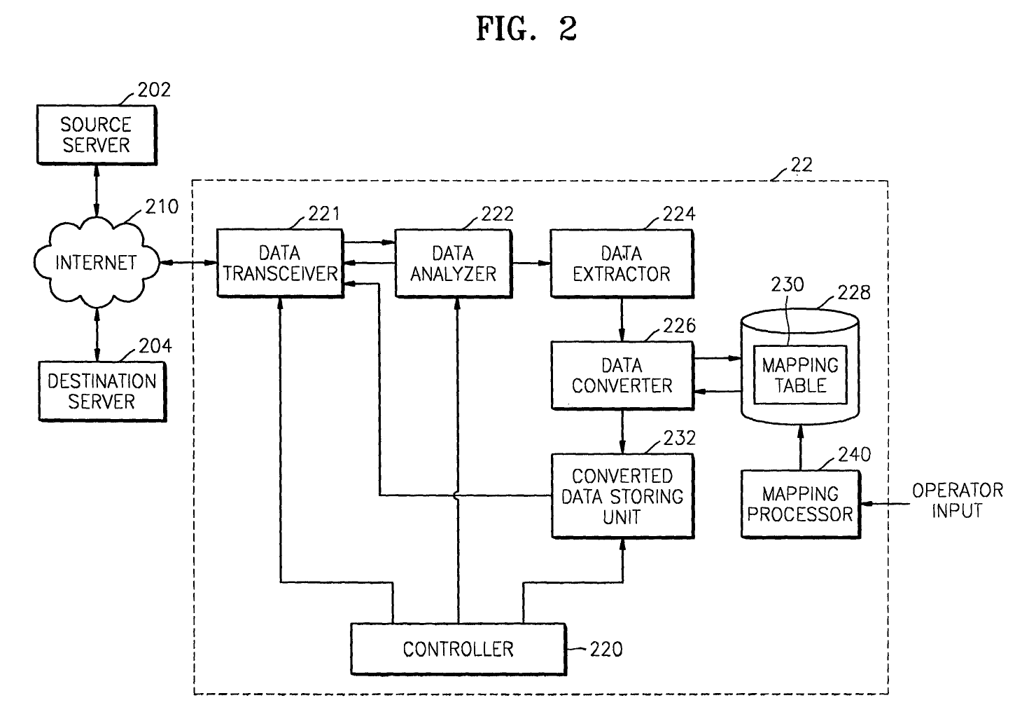

A home page moving method according to an embodiment of the present invention shown in FIG. 1 is performed within a home page moving device according to an embodiment of the invention shown in FIG. 2. Referring to FIG. 2, a home page moving device 22 according to the invention is connected to the Internet 210. Further, a server for storing home page data to be moved, i.e., a source server 202, and a server to which the home page data is to be moved, i.e., a destination server 204, are connected to the Internet 210. The home page moving device 22 includes a controller 220, a data transceiver 221, a data analyzer 222, a data extractor 224, a data converter 226, a mapping database 228, and a mapping processor 240. A mapping table 230 is stored in the mapping database 228.

The operation of the home page moving device 22 is described as follows. First, the data transceiver 221 receives a hypertext markup language (HTML) file corresponding to a main home page from the source server 202 (step 102). The data extractor 224 extracts data requiring modification from the HTML file received through the data transceiver 221 by parsing. Parsers for performing parsing are well known to those skilled in the art, and thus a detailed explanation will be omitted.

The data converter 226 then converts the extracted data into a format well suited for the destination server 204 by referring to the mapping table 230 provided in the mapping database 228 (step 106). The converted data is stored in a converted data storing unit 232 on a page-by-page basis. The mapping table 230 is created by the mapping processor 240. An operator can make a mapping table by considering the environments of a common gateway interface (CGI), a database, a bulletin board of the source server 202, and a bulletin board of the destination server 204. The mapping processor 240 is an interface between the operator and the mapping database 228. However, when considering all possible environments of a CGI, a database, and a bulletin board, automatic conversion of data can be made without requiring the user to make the mapping table.

Next, the data analyzer 222 determines whether a next page exists in a hierarchical manner (step 108). For example, if a uniform resource locator (URL), which is an address identifying the location of information such as an Internet web site, a web page, or graphics contained in the web page, is detected within the page received through the data transceiver 221, it may be determined that a next page exists on a hierarchical basis. There may be a plurality of web pages contained in the data of a main home page, or the plurality of web pages may also contain other web pages. Thus, the home page moving method, according to the invention, involves sequentially determining whether or not next web pages exist for all the web pages existing within the main home page. If it is determined that next pages exist, then it is determined whether or not a next web page exists within a current web page. This determination will be referred to as a hierarchical determination.

If it is determined that a next page exists in the step 108, the data analyzer 222 requests the data transceiver 221 to send the next page, and the data transceiver 221 sends a request for the corresponding page to the source server 202 through the Internet 210. In response to the request for the corresponding page, the source server 202 then sends the requested page through the Internet 210. In this way, the home page moving device 22 receives an HTML file of the corresponding page (step 110).

On the other hand, if it is determined that no next page exists in the step 108, an HTML file, including the converted data, is transferred and transplanted to the destination server 204 (step 112). Furthermore, the controller 220 controls the timing of data transmission/reception performed by the data transceiver 221, the hierarchical analysis of home page data and home page data request operations performed by the data analyzer 222, and the storage and output operations performed by the converted data storing unit 232.

Commonly, in order to record an HTML file, including converted data, in a destination server, prior approval of the destination server needs to be obtained, but this embodiment was described assuming that this approval had already been obtained.

The home page moving method and the device therefor, according to the present invention, can quickly move a home page from one server to another server.

Furthermore, the home page moving method according to the invention can be written as a program executed on a personal or server computer. Computer programmers in the industry can easily infer the program codes and code segments constructing the program. Furthermore, the program can be stored in a computer-readable recording medium. The recording medium includes a magnetic recording medium, an optical recording medium, and a radio medium.

What is claimed is:

1. A home page moving method for moving a home page from one server to another server, comprising the steps of:
(a) receiving main home page data from a source server in which home page data to be moved is stored;
(b) extracting data requiring modification from the received data;
(c) converting the extracted data into a format suited for a destination server by referring to a mapping table for storing mapping relationships, said mapping relationships are determined by the environments of the source server and the destination server; and
(d) transferring and transplanting data including the converted data to the destination server.

2. The home page moving method of claim 1, prior to the step (d), further comprising the steps of:
(pd-1) determining whether or not a next page exists in a hierarchical manner;
(pd-2) if it is determined that a next page exists in the step (pd-1), sending a request for the corresponding page to the source server;
(pd-3) receiving the requested page from the source server; and
(pd-4) if it is determined that a next page does not exist in the step (pd-1), proceeding with the step (d).

3. The home page moving method of claim 2, wherein, in the step (pd-1), when a uniform resource locator (URL) is detected, it is determined that a next page exists in a hierarchical manner.

4. A computer-readable recording medium in which a computer program for performing a home page moving method for moving a home page from one server to another server is stored, the computer program comprising instructions for performing a home page moving method including the steps of:
(a) receiving main home page data from a source server in which home page data is stored;
(b) extracting data requiring modification from the received data;
(c) converting the extracted data into a format suited for the destination server by referring to a mapping table for storing mapping relationships, said mapping relationships are determined by the environments of the source server and the destination server; and
(d) transferring and transplanting data, including the converted data, to the destination server.

5. The computer readable recording medium of claim 4, wherein the instructions include program codes.

6. The computer-readable recording medium of claim 4, wherein, prior to the step (d), the home page moving method further comprises the steps of:
(pd-1) determining whether or not a next page exists in a hierarchical manner;
(pd-2) if it is determined that a next page exists in the step (pd-1), sending a request for the corresponding page to the source server;
(pd-3) receiving the requested page from the source server; and
(pd-4) if it is determined that a next page does not exist in the step (pd-1), proceeding with the step (d).

7. The computer-readable recording medium of claim 6, wherein, in the step (pd-1), when a uniform resource locator (URL) is detected, it is determined that the next page exists in a hierarchical manner.

8. A device comprising:
a mapping table for mapping home page data stored in a source server into home page data to be stored in a destination server based on the environments of a common gateway interface (CGI), a database, a bulletin board of the source server, and a bulletin board of the destination server; and
a data converter for converting the home page data stored in the source server into a format suited for the destination server by referring to the mapping table.

9. The device of claim 8, further comprising a data transceiver for receiving the home page data from the source server and transmitting data, including the converted data, to the destination server.
